(19) United States
(12) Patent Application Publication
(10) Pub. No.: US 2011/0060086 A1
(43) Pub. Date: Mar. 10, 2011

(54) Elastomeric Copolymers, Copolymer Compositions, and Their Use in Articles

(76) Inventors: Michael Brendan Rodgers, Seabrook, TX (US); Weiqing Weng, Houston, TX (US); John Patrick Soisson, Houston, TX (US); Robert Norman Webb, Kingwood, TX (US); Sunny Jacob, Seabrook, TX (US)

(21) Appl. No.: 12/861,414

(22) Filed: Aug. 23, 2010

Related U.S. Application Data
(60) Provisional application No. 61/241,280, filed on Sep. 10, 2009.

(51) Int. Cl. C08L 27/00; C08F 12/16; C08L 9/00; C08L 77/00; C08L 35/04; C08L 41/00; C08L 25/06; C08L 37/00; C08L 29/00; C08K 3/26; C08K 3/22; C08K 3/34

(52) U.S. Cl. 524/424; 526/293; 525/55; 525/235; 524/551; 525/184; 525/217; 525/212; 525/241; 525/207; 525/220; 525/231; 524/430; 524/451; 524/447; 524/443

(57) ABSTRACT

A copolymer is formed from an isoolefin having from 4 to 7 carbon atoms and an alkylstyrene. The copolymer has a substantially homogeneous compositional distribution. The copolymer has from about 8 to about 12 wt % of alkylstyrene and at least 85 wt % of isoolefin. The copolymer is preferably halogenated with about 1.1 to about 1.5 wt % of a halogen. The copolymer may in elastomeric nanocomposites. To obtain a good dispersion of the nanoclay in a formulated compound, at least one cure accelerator is selected from the group consisting of mercaptobenzothiazole disulfide, mercaptobenzothiazole, cyclohexyl benzothiazole disulfide, dibutyl thiourea, tetramethylthiuram disulfide, 4-4-dithiodimropholine, zinc dimethyldithiocarbamate, and zinc dibutylphosphorodithiate.

### CROSS REFERENCE TO RELATED APPLICATIONS

This application claims the benefit of prior U.S. Provisional Application Ser. No. 61/241,280 filed Sep. 10, 2009 which is hereby incorporated by reference in its entirety.

### FIELD OF THE INVENTION

The present invention is related to elastomeric copolymers, compositions comprising the elastomeric compositions, and the use of the copolymers in articles. More particularly, the present invention is directed to a halogenated C4 to C7 isoolefin based copolymer having improved performance properties and blending characteristics.

### BACKGROUND

The adoption of new technology polymers and compounds by the tire and rubber industry has led to many product performance improvements. For example, in the 1970's new technology carbon blacks that were used in tire treads led to improvements in tread wear. In the 1980's the expansion of the use of SiCl14 and TiCl4 coupled rubbers led to reductions in tire rolling resistance and improvements in fuel economy without the previously traditional trade-off between traction and wear. In the 1990's the introduction of highly dispersible silica and semi highly dispersible silica advanced tire durability and performance.

For tire innerliners, and other elastomeric articles, where impermeability characteristics are required, there have also been advancements. New technologies have taken the industry from natural rubber to synthetic butyl rubbers to halogenated butyl rubbers to isoolefin-alkylstyrene copolymers (see U.S. Pat. No. 5,162,445 and U.S. Pat. No. 5,333,662) to thermoplastic thermoelastic alloys to copolymers bonded to incorporated fillers, i.e., nanocomposites.

Elastomeric nanocomposites essentially consist of a base polymer and a nanoclay. Nanoclays, having a size measured in the order of microns, are a collection or agglomerate of individual plates or layers with negatively charged ions on the surface of the individual plates or layers. Depending on the class of nanoclay, the plates can range in dimension from 10 nm for Kaolin clays to 70 nm to 100 nm for montmorillonite clays and 500 nm for vermiculites. It is the dimension of the clay that defines it as a “nanoclay’ and due to the size will act differently in dispersions in comparison to regular clays. For further clarity, a nanoclay can also be described as a clay which can be modified so that it will ultimately be dispensable as single layered plates, nominally 1 nm in thickness, in another substance to form a nanocomposite. The modification process for the nanoclay can be either through addition of a chemical additive, such as a surfactant, to render the nanoclay compatible with non-polar polymers, or through processing methods such as the formation of an emulsion dispersible in a polymer network or matrix. After such modification, the nanoclay is what is known in the art as an ‘organoclay.’

Layered clays have been widely used in various applications. When used, the nanoclay may adapt to one of five different states in the base polymer.

The first state is “particle dispersion” wherein the nanoclay particle size is in the order of microns but uniformly dispersed in the base polymer. The terms aggregate and agglomerate have been used to describe this state.

The second state is an “intercalated nanocomposite” wherein polymer chains are inserted into the layered nanoclay structure, this occurring in a crystallographic regular fashion, regardless of the polymer to nanoclay ratio. Intercalated nanocomposites may typically contain multiple polymer chains between the nanoclay plates. An increase in the gallery spacing of the nanoclay, swollen with polymer, occurs and can be considered as creating an intercalated condition.

The third state is a “flocculated nanocomposite.” This is conceptually the same as intercalated nanocomposites; however, the individual nanoclay layers are sometimes flocculated or aggregated due to, for example, hydroxylated edge to edge interactions of the nanoclay layers.

The fourth state is an “intercalated-flocculated nanocomposite.” The nanoclay plates in the nanocomposite can be separated; however, tactoids or agglomerates can form that have a thickness in the range of 100 to 500 nm.

The fifth state is an “exfoliated nanocomposite.” In an exfoliated nanocomposite, the individual nanoclay layers are separated within a continuous polymer by an average distance that depends on the nanoclay concentration or loading in the polymer.

At each advancement in technology, improvements have been obtained in permeability characteristics of the copolymers. However, as different components are introduced and/or blended with the isoolefin based polymer, other properties of the polymer can be negatively affected, and the presumed trend in impermeability and blending characteristics does not always prove to be the rule.

### SUMMARY OF THE INVENTION

The present invention is directed to a copolymer having improved capabilities for use in articles requiring impermeability features, such as tire innerliners, tire innertubes, tire curing bladders, hoses, medical stoppers, impermeability sheets, and other similar items.

The present invention is directed to a copolymer of an isoolefin having from 4 to 7 carbon atoms and an alkylstyrene. The copolymer has a substantially homogeneous compositional distribution of the isoolefin and alkylstyrene. The copolymer has from about 8 to about 12 wt % of alkylstyrene and at least 85 wt % of isoolefin. The copolymer is preferably halogenated and has from about 1.1 to about 1.5 wt % of a halogen. The copolymer has a molecular weight distribution (MWD/Mw/Mn) of less than about 6.

In one aspect of the present invention, the halogenation of the copolymer is accomplished with either chlorine or bromine.

In another aspect of the invention, the alkylstyrene content of the copolymer is para-methylstyrene and the isoolefin content of the copolymer is isobutylene.

In another aspect of the invention, the alkylstyrene of the copolymer is functionalized with the halogen, and up to 25 mol % of the alkylstyrene is so functionalized. In a further embodiment, from 10 to 25 mol % of the alkylstyrene is functionalized by the halogen.

In another aspect of the invention, the copolymer is blended with a secondary polymer to form a compound, the compound containing from 5 to 90 phr of the copolymer. The secondary polymer may be selected from the group consisting of natural rubbers, polybutadiene rubber, polyisoprene rubber, poly(styrene-co-butadiene) rubber, poly(isoprene-co-butadiene) rubber, styrene-isoprene-butadiene rubber, ethylene-propylene rubber, ethylene-propylene-diene rubber, isobutene-isoprene rubber, halogenated butyl rubber, star branched butyl rubber, and mixtures thereof.

In another aspect of the invention, the copolymer may be blended with at least one component selected from the group consisting of fillers, processing oils, and cure packages.

In another aspect of the invention, the copolymer may be blended with a thermoplastic polymers selected from the group consisting of polyamides, polyimides, polycarbonates, polyesters, polysulfones, polylactones, polyacetals, acrylonitrile-butadiene-styrene polymers, polyphenyleneoxide, polyphenylene sulfide, polystyrene, styrene-acrylonitrile polymers, styrene maleic anhydride polymers, aromatic polyketones, poly(phenylene ether), and mixtures thereof. In one aspect of this embodiment of the invention, the copolymer and the thermoplastic polymer are dynamically vulcanized together under conditions of high shear wherein the copolymer is dispersed as fine particles within the thermoplastic polymer.

In another aspect of the invention, the copolymer is blended with at least one nanofiller. The nanofiller may be a silicita, graphene, carbon nanotube, expandable graphite oxide, carbonate, metal oxide, or talc. In one aspect of this embodiment, the nanofiller is a silicate. The silicate may be selected from the group consisting of natural or synthetic phyllosilicates, montmorillonite, nontronite, beidellite, bentonite, volkonskoite, laponite, hectorite, saponite, sauconite, magadite, kenyaite, stevensite, vermiculite, halloysite, aluminate oxides, and hydrotalcite.

In another aspect of the invention wherein the copolymer is used to form a nanocomposite, when being formulated as an elastomeric reinforced compound, at least one cure accelerator is used in the compound. The cure accelerator may be selected from the group consisting of mercaptobenzothiazole disulfide, mercaptobenzothiazole, cyclohexyl benzothiazole disulfide, dibutyl thiourea, tetramethylthiuram disulfide, 4-4-dithiodimropholine, zinc dimethyldithiocarbamate, and zinc dibutylphosphorodithiate.

### BRIEF DESCRIPTION OF THE DRAWING(S)

FIG. 1 shows TEM micrographs of an uncompounded nanocomposite taken at 200 nm and 20 nm.

FIG. 2 shows TEM micrograph of formulated nanocomposites taken at 50 nm.

FIG. 3 shows TEM micrograph of formulated nanocomposites taken at 50 nm.

### DETAILED DESCRIPTION OF THE INVENTION

Various specific embodiments, versions, and examples of the invention will now be described, including preferred embodiments and definitions that are adopted herein for purposes of understanding the claimed invention. While the illustrative embodiments have been described with particularity, it will be understood that various other modifications will be apparent to and can be readily made by those skilled in the art without departing from the spirit and scope of the invention. For determining infringement, the scope of the “invention” will refer to any one or more of the appended claims, including their equivalents and elements or limitations that are equivalent to those that are recited.

### DEFINITIONS

Definitions applicable to the presently described invention are as described below.

Rubber refers to any polymer or composition of polymers consistent with the ASTM D1566 definition: “a material that is capable of recovering from large deformations, and can be, or already is, modified to a state in which it is essentially insoluble (but can swell) in boiling solvent . . . ”. Elastomer is a term that may be used interchangeably with the term rubber.

Elastomeric composition refers to any composition comprising at least one elastomer as defined above.

A vulcanized rubber compound by ASTM D1566 definition refers to “a crosslinked elastic material compounded from an elastomer, susceptible to large deformations by a small force capable of rapid, forceful recovery to approximately its original dimensions and shape upon removal of the deforming force”. A cured elastomeric composition refers to any elastomeric composition that has undergone a curing process and/or comprises or is produced using an effective amount of a curative or cure package, and is a term used interchangeably with the term vulcanized rubber compound.

The term “phr” is parts per hundred rubber or “parts”, and is a measure common in the art wherein components of a composition are measured relative to a total of all of the elastomer components. The total phr or parts for all rubber components, whether one, two, three, or more different rubber components is present in a given recipe is always defined as 100 phr. All other non-rubber components are ratioed against the 100 parts of rubber and are expressed in phr. This way one can easily compare, for example, the levels of curatives or filler loadings, etc., between different compositions based on the same relative proportion of rubber without the need to recalculate percents for every component after adjusting levels of only one, or more, component(s).

Hydrocarbon refers to molecules or segments of molecules containing primarily hydrogen and carbon atoms. In some embodiments, hydrocarbon also includes halogenated versions of hydrocarbons and versions containing heteroatoms as discussed in more detail below.

Alkyl refers to a paraffinic hydrocarbon group which may be derived from an alkane by dropping one or more hydrogens from the formula, such as, for example, a methyl group (CH₃), or an ethyl group (CH₃CH₂), etc.

Aryl refers to a hydrocarbon group that forms a ring structure characteristic of aromatic compounds such as, for example, benzene, naphthalene, phenanthrene, anthracene, etc., and typically possess alternate double bonding (“unsaturation”) within its structure. An aryl group is thus a group derived from an aromatic compound by dropping one or more hydrogens from the formula such as, for example, phenyl, or C₆H₅.

Substituted refers to at least one hydrogen group being replaced by at least one substituent selected from, for example, halogen (chlorine, bromine, fluorine, or iodine), amino, nitro, sulfoxy (sulfonate or alkyl sulfonate), thiol, alkylthiol, and hydroxy; alkyl, straight or branched chain having 1 to 20 carbon atoms which includes methyl, ethyl, propyl, isopropyl, normal butyl, isobutyl, secondary butyl, tertiary butyl, etc.; alkoxy, straight or branched chain alkoxy having 1 to 20 carbon atoms, and includes, for example, methoxy, ethoxy, propoxy, isopropoxy, butoxy, isobutoxy, secondary butoxy, tertiary butoxy, pentyloxy, isopentyloxy, hexyloxy, heptryloxy, octyloxy, nonyloxy, and decyloxy; haloalkyl, which means straight or branched chain alkyl having 1 to 20 carbon atoms which is substituted by at least one halogen, and includes, for example, chloromethyl, bromomethyl, fluoromethyl, iodomethyl, 2-chloroethyl, 2-bromoethyl, 2-fluoroethyl, 3-chloropropyl, 3-bromopropyl, 3-fluoropropyl, 4-chlorobutyl, 4-fluorobutyl, dichloromethyl, dibromomethyl, difluoromethyl, diiodomethyl, 2,2-dichloroethyl, 2,2-dibromoethyl, 2,2-difluoroethyl, 3,3-dichloropropyl, 3,3-difluoropropyl, 4,4-dichlorobutyl, 4,4-dibromobutyl, 4,4-difluorobutyl, trichloromethyl, trifluoromethyl, 2,2,2-trifluoroethyl, 2,3,3-trifluoropropyl, 1,1,2,2-tetrafluoroethyl, and 2,2,3,3-tetrafluoropropyl. Thus, for example, a “substituted styrenic unit” includes p-methylstyrene, p-ethylstyrene, etc.

### Halogenated Isobutylene-Para-Methylstyrene Rubber

In accordance with the present invention, the copolymer is a random copolymer comprising a C₄ to C₇ isoolefins derived units and alkylstyrene, the copolymer containing at least 85%, more alternatively at least 86.5% by weight of the isoolefin, about 8 to about 12% by weight alkylstyrene, and about 1.1 to about 1.5 wt % of a halogen. In one embodiment, the polymer may be a random elastomeric copolymer of a C₄ to C₇ α-olefin and a methylstyrene containing at about 8 to about 12% by weight methylstyrene, and 1.1 to 1.5 wt % bromine or chlorine. Exemplary materials may be characterized as polymers containing the following monomer units randomly spaced along the polymer chain:

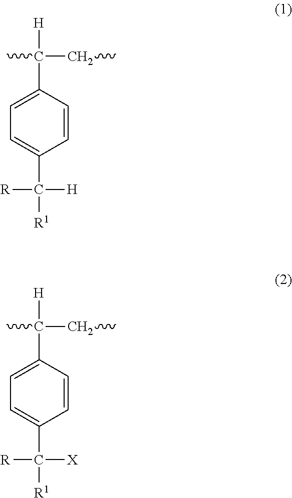

wherein R and R¹ are independently hydrogen, lower alkyl, such as a Cᵢ to C₇ alkyl and primary or secondary alkyl halides and X is a halogen. In one embodiment, R and R¹ are each hydrogen.

Up to 25 mol % of the total alkyl substituted styrene [the total of structures (1) and (2)] present in the random polymer structure may be the halogenated alkyl substituted structure (2) above in one embodiment, and in another embodiment from 10 to 25 mol %. In yet another embodiment, the amount of functionalized structure (2) in the random copolymer itself is from about 0.8 to about 1.10 mol %. In yet another embodiment, the random copolymer has 0.8 to 1.10 mol % of functional halogen.

In one embodiment, the elastomer comprises random polymers of isobutylene and para-methylstyrene (PMS) containing from about 4 to about 10 mol % para-methylstyrene wherein up to 25 mol % of the methyl substituent groups present on the benzyl ring contain a bromine or chlorine atom, such as a bromine atom (para-(bromomethylstyrene)), as well as acid or ester functionalized versions thereof.

In another embodiment, the functionality is selected such that it can react or form polar bonds with functional groups present in the matrix polymer, for example, acid, amino or hydroxyl functional groups, when the polymer components are mixed at high temperatures.

In certain embodiments, the random copolymers have a substantially homogeneous compositional distribution such that at least 95% by weight of the polymer has a para-alkylstyrene content within 10% of the average para-alkylstyrene content of the polymer. Exemplary polymers are characterized by a narrow molecular weight distribution (Mw/Mn) of less than 4.0, alternatively less than 2.5. The copolymers have an exemplary viscosity average molecular weight in the range of from 400,000 up to 2,000,000 and an exemplary number average molecular weight in the range of from 100,000 to 750,000 as determined by gel permeation chromatography.

The random copolymer discussed above may be prepared via slurry polymerization, typically in a diluent comprising a halogenated hydrocarbon(s) such as a chlorinated hydrocarbon and/or a fluorinated hydrocarbon (see e.g., WO 2004/058827 and WO 2004/058828), using a Lewis acid catalyst and optionally a catalyst initiator, followed by halogenation, preferably bromination, in solution in the presence of the halogen and a radical initiator such as heat and/or light and/or a chemical initiator and, optionally, followed by substitution of the halogen with a different functional moiety.

In an embodiment, halogenated poly(isobutylene-co-p-methylstyrene) polymers generally contain from about 0.7 to about 1.1 mol % of halo-methylstyrene groups relative to the total amount of monomer derived units in the copolymer. In another embodiment, the amount of halo-methylstyrene groups is from 0.80 to 1.10 mol %, and from 0.80 to 1.00 mol % in yet another embodiment, and from 0.85 to 1.1 mol % in yet another embodiment, and from 0.85 to 1.0 in yet another embodiment, wherein a desirable range may be any combination of any upper limit with any lower limit. Expressed another way, the copolymers of the present invention contain from about 1.1 to about 1.5 wt % of halogen, based on the weight of the polymer, from 1.1 to 1.5 wt % halogen in another embodiment, and from 1.15 to 1.45 wt % in another embodiment. In a preferred embodiment, the halogen is either bromine or chlorine; in a most preferred embodiment, the halogen is bromine.

In another embodiment, the copolymers are substantially free of ring halogen or halogen in the polymer backbone chain. In one embodiment, the random polymer is a copolymer of C₄ to C₇ isoolefin derived units (or isomonoolefin), para-methylstyrene derived units and para-(halomethylstyrene) derived units, wherein the para-(halomethylstyrene) units are present in the polymer from about 10 to about 22 mol % based on the total number of para-methylstyrene, and wherein the para-methylstyrene derived units are present from 8 to 12 wt % based on the total weight of the polymer in one embodiment, and from 9 to 10.5 wt % in another embodiment. In another embodiment, the para-(halomethylstyrene) is para-(bromomethylstyrene).

Comparative samples of both commercial bromobutyl rubber and commercial para-bromomethylstyrene isobutylene were compared to a copolymer having styrene and bromine amounts within the present invention. The different compounds are set forth below in Table 1.

TABLE 1

| | Mooney | | | | |
|---|---|---|---|---|---|
| | Viscosity | | | | |
| | (ML1 + 8 @ | Isoprene | PMS | BR | BR |
| Polymer | 125° C.) | (mol %) | (wt %) | (wt %) | (mol %) |
| Bromobutyl | 32 | 1.70 | — | 2.0 | |
| 2222¹ | | | | | |
| Bromobutyl | 46 | 1.70 | — | 2.0 | |
| 2255² | | | | | |
| BIMSM A | 45 | — | 5.0 | | 0.47 |
| BIMSM B | 35 | — | 5.0 | | 0.75 |
| BIMSM C | 45 | — | 7.5 | | 1.20 |
| BIMSM X | 35 | — | 10.0 | | 0.85 |

¹Bromobutyl 2222, from ExxonMobil Chemical Company, Houston, Tx. Typical Mooney viscosity ranges from 27 to 37, with a bromine content from 1.8 to 2.2 wt %
²Bromobutyl 2255, from ExxonMobil Chemical Company, Houston, Tx. Typical Mooney viscosity ranges from 41 to 51, with a bromine content from 1.8 to 2.2 wt %

To illustrate the comparative properties of a commercial bromobutyl, different para-bromomethylstyrene isobutylene copolymers, compounds using the six isobutylene based polymers were prepared using a model industrial tire innerliner formulation. The compound formulations are set forth in Table 2. All components in the compounds are provided in parts per hundred (phr).

TABLE 2

| Compound | 1 | 2 | 3 | 4 | 5 |
|---|---|---|---|---|---|
| Bromobutyl 2222 | 100.00 | | | | |
| BIMSM A | | 100.00 | | | |
| BIMSM B | | | 100.00 | | |
| BIMSM C | | | | 100.00 | |
| BIMSM X | | | | | 100.00 |
| Carbon Black | 60.00 | 60.00 | 60.00 | 60.00 | 60.00 |
| Napthanic oil¹ | 8.00 | 8.00 | 8.00 | 8.00 | 8.00 |
| Resin² | 7.00 | 7.00 | 7.00 | 7.00 | 7.00 |
| Phenolic tackifier | 4.00 | 4.00 | 4.00 | 4.00 | 4.00 |
| Stearic acid | 1.00 | 1.00 | 1.00 | 1.00 | 1.00 |
| Zinc oxide | 1.00 | 1.00 | 1.00 | 1.00 | 1.00 |
| MBTS³ | 1.25 | 1.25 | 1.25 | 1.25 | 1.25 |
| Sulfur | 0.50 | 0.50 | 0.50 | 0.50 | 0.50 |

¹ASTM type 103; available as CALSOL ™ 810 form R.E. Carroll, Inc, Trenton, NJ
²STRUKTOL ™ 40 MS; composition of aliphatic-aromatic-naphthenic resin; available from Struktol Co. of America, Stow, OH
³2-mercaptobenzothiazole disulfide; available from R.T. Vanderbilt (Norwalk, CT) or Elastochem (Chardon, OH)

Each of the elastomer compounds of Table 2 were tested for physical properties, the results of which are reported below.

TABLE 3

| Compound | 1 | 2 | 3 | 4 | 5 |
|---|---|---|---|---|---|
| Mooney Viscosity, 100° C. | | | | | |
| ML(1 + 4), [MU] ASTM D1646 | 53.7 | 62.4 | 55.7 | 62.5 | 50.2 |
| Mooney Scorch on MV2000, 125° C. ASTM | | | | | |
| D1646 | | | | | |
| Minimum viscosity | 37 | 47 | 38 | 49 | 34 |
| t10, min. | 31.9 | 47.2 | 33.6 | 21.4 | 30.8 |
| Rheometer (MDR), ASTM D5038 | 160° C. | | | | |
| MH-ML, dNm | 3.4 | 3.7 | 6.7 | 11.9 | 6.6 |
| t10, minutes | 2.1 | 3.4 | 3.8 | 3.1 | 3.6 |
| t90, minutes | 8.3 | 14.2 | 10.3 | 9.0 | 10.6 |
| Rate, dNm/min | 0.8 | 0.5 | 1.3 | 2.9 | 1.2 |
| Rheometer (MDR), ASTM D5038 | 180° C. | | | | |
| MH-ML, dNm | 3.3 | 3.7 | 6.9 | 12.6 | 6.7 |
| t10, min | 0.9 | 1.5 | 1.5 | 1.2 | 1.4 |
| t90, min | 2.5 | 4.7 | 3.8 | 3.9 | 3.7 |
| Rate, dNm/min | 2.4 | 1.6 | 4.1 | 8.9 | 3.7 |
| Tensile Strength, MPa, ASTM D412 | 8.5 | 7.6 | 8.0 | 8.6 | 8.0 |
| Elongation at break, %, ASTM D412 | 845 | 1000 | 745 | 410 | 740 |
| 300% Modulus, MPa, ASTM D412 | 2.6 | 2.4 | 4.6 | 7.5 | 4.5 |
| Shore Hardness A, ASTM D2240 | 43 | 46 | 53 | 61 | 53 |
| Die B Tear Strength, N/mm, ASTM D624 | 36.7 | 39.0 | 31.3 | 22.7 | 30.8 |
| Dynamic Properties, 10 Hz at 30° C., 2% | | | | | |
| G′, MPa | 4.408 | 4.592 | 5.714 | 7.618 | 6.034 |
| G″, MPa | 1.102 | 1.149 | 1.364 | 1/825 | 1.744 |
| G*, MPa | 4.544 | 4.734 | 5.875 | 7.833 | 6.281 |
| tan_delta | 0.250 | 0.250 | 0.239 | 0.240 | 0.289 |
| Permeability | | | | | |
| Permeation Rate, cc * mm/m² · day | 265 | 231 | 228 | 209 | 192* |
| Permeation Coeff., cc * mm/m² · | 0.393 | 0.343 | 0.338 | 0.31 | 0.28* |
| day · mmHg | | | | | |
| Rating | 100 | 87 | 86 | 79 | — |

*average of 17 compounds and 14 test specimens

The test data in Table 3 evidences a few relevant points about compound BIMSM X in comparison to the commercial bromobutyl copolymer and the other para-bromomethylstyrene isobutylene copolymers when compounded.

In comparison to the bromobutyl based compound, the para-bromomethylstyrene isobutylene copolymer based compounds have higher viscosities. Compound 5 comprising the para-bromomethylstyrene isobutylene in accordance with the present invention, has a viscosity comparable to the bromobutyl based compound 1. For compounded elastomers, a lower viscosity is desirable for handling purposes and for sustaining an extruded shape during any green, or uncured, building stages.

Vulcanization induction times and cure state, as evidenced by the rheometer data, for the para-bromomethylstyrene isobutylene copolymer based compounds 2 to 4 are higher than for the bromobutyl based compound 1. Compound 4, having the highest bromine, show the highest cure state. Crossing linking of the BIMSM occurs via a Friedel-Crafts alkylation reaction catalyzed by zinc bromide; thus the higher the bromine content, the greater the cross-linking density. However, if the amount of bromine in the base copolymer is too high, the elongation at break and tear strength properties of the elastomeric compound is compromised. This is seen in comparing compounds 4 and 5: for compound 4, comprising a 1.2 mol % Br copolymer, the elongation at break is only 410, while for compound 5, comprising a 0.85 mol % Br copolymer, elongation at break is higher at 740%. For many repetitive cycle applications (e.g., tires, tire curing bladders), to prevent cracking and ensure adequate fatigue resistance, a nominal elongation at break of at least 700% is desired.

In regards to permeability characteristics of the compound, the compound permeability decreases 13 to 14% for the BIMSM containing compounds having 5 wt % PMS in comparison to the bromobutyl based compound. For the 7.5 wt % PMS containing BIMSM, the compound has a 21% decrease in permeability. For the 10% PMS containing BIMSM, the compound has a 27.5% decrease in permeability.

Overall, the BIMSM copolymer having the higher para-methylstyrene content and lower bromine content exhibits the most balance of vulcanization kinetics, compound mechanical properties, and permeability when blended in a compound.

In one embodiment, the halogenated paramethylstyrene isobutylene copolymer having the para-methylstyrene and bromine content as discussed above may be the sole elastomeric component of a compound; thereby taking full advantage of the above noted benefits. Alternatively in other embodiments, the inventive copolymer may be blended with a different/secondary elastomeric polymer to obtain a compound having other desired properties or characteristics.

Examples of other elastomeric polymers include natural rubbers (NR), polybutadiene rubber (BR), polyisoprene rubber (IR), poly(styrene-co-butadiene) rubber (SBR), poly(isoprene-co-butadiene) rubber (IBR), styrene-isoprene-butadiene rubber (SIBR), ethylene-propylene rubber (EPM), ethylene-propylene-diene rubber (EPDM), isobutene-isoprene rubber (butyl rubber, IIR), halogenated butyl rubber (HIIR) such as chlorinated butyl rubber or brominated butyl rubber, star branched butyl rubber (SBB), and mixtures thereof.

When blended in a compound, the presently disclosed elastomer, either individually or as a blend of different elastomers (i.e., reactor blends, physical blends such as by melt mixing), may be present in the composition from 10 phr to 90 phr in one embodiment, and from 10 to 80 phr in another embodiment, and from 30 to 70 phr in yet another embodiment, and from 40 to 60 phr in yet another embodiment, and from 5 to 50 phr in yet another embodiment, and from 5 to 40 phr in yet another embodiment, and from 20 to 60 phr in yet another embodiment, and from 20 to 50 phr in yet another embodiment, the chosen embodiment depending upon the desired end use application of the composition.

Such secondary rubbers may be present in the final composition in amounts ranging from 5 to 90 phr. To obtain a greater impermeability, the use of polymers having lesser permeability characteristics will be limited to minor amounts, i.e., less than 50 phr, in the elastomeric blend.

### Thermoplastic Polymer

In other embodiments, the elastomeric compositions may comprise at least one thermoplastic polymer. A thermoplastic (alternatively referred to as thermoplastic resin) is a thermoplastic polymer, copolymer, or mixture thereof having a Young's modulus of more than 300 MPa at 23° C. The resin should have a melting temperature of about 170° C. to about 260° C., preferably less than 260° C., and most preferably less than about 240° C. By conventional definition, a thermoplastic is a synthetic resin that softens when heat is applied and regains its original properties upon cooling.

Thermoplastic polymers suitable for practice of the present invention may be used singly or in combination and are polymers containing nitrogen, oxygen, halogen, sulfur or other groups capable of interacting with an aromatic functional groups such as halogen or acidic groups. The polymers are present in the blended composition from 30 to 90 wt % of the composition in one embodiment, and from 40 to 80 wt % in another embodiment, and from 50 to 70 wt % in yet another embodiment. In yet another embodiment, the polymer is present at a level of greater than 40 wt % of the composition, and greater than 60 wt % in another embodiment.

Suitable thermoplastic resins include resins selected from the group consisting or polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK), ethylene copolymer resins (EVA or EVOH) and mixtures thereof.

Suitable thermoplastic polyamides (nylons) comprise crystalline or resinous, high molecular weight solid polymers including copolymers and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines. Both fiber-forming and molding grade nylons are suitable. Examples of such polyamides are polycaprolactam (nylon-6), polylauryllactam (nylon-12), polyhexamethyleneadipamide (nylon-6,6) polyhexamethyleneazelamide (nylon-6,9), polyhexamethylenesebacamide (nylon-6,10), polyhexamethyleneisophthalamide (nylon-6, IP) and the condensation product of 11-amino-undecanoic acid (nylon-11). Commercially available thermoplastic polyamides may be advantageously used in the practice of this invention, with linear crystalline polyamides having a softening point or melting point between 160 and 260° C. being preferred.

Suitable thermoplastic polyesters which may be employed include the polymer reaction products of one or a mixture of aliphatic or aromatic polycarboxylic acids esters of anhydrides and one or a mixture of diols. Examples of satisfactory polyesters include poly (trans-1,4-cyclohexylene C₂₋₆ alkane dicarboxylates such as poly(trans-1,4-cyclohexylene succinate) and poly (trans-1,4-cyclohexylene adipate); poly (cis or trans-1,4-cyclohexanedimethylene) alkanedicarboxylates such as poly(cis-1,4-cyclohexanedimethylene) oxlate and poly-(cis-1,4-cyclohexanedimethylene) succinate, poly (C₂₋₄ alkylene terephthalates) such as polyethyleneterephthalate and polytetramethylene-terephthalate, poly (C₂₋₄ alkylene isophthalates such as polyethyleneisophthalate and polytetramethylene-isophthalate and like materials. Preferred polyesters are derived from aromatic dicarboxylic acids such as naphthalenic or phthalic acids and C₂ to C₄ diols, such as polyethylene terephthalate and polybutylene terephthalate. Preferred polyesters will have a melting point in the range of 160° C. to 260° C.

Other thermoplastic polymers which may be used include the polycarbonate analogs of the polyesters described above such as segmented poly (ether co-phthalates); polycaprolactone polymers; styrene polymers such as copolymers of styrene with less than 50 mol % of acrylonitrile (SAN) and resinous copolymers of styrene, acrylonitrile and butadiene (ABS); sulfone polymers such as polyphenyl sulfone; copolymers and homopolymers of ethylene and C₂ to C₈ α-olefins, in one embodiment a homopolymer of propylene derived units, and in another embodiment a random copolymer or block copolymer of ethylene derived units and propylene derived units, and like thermoplastic polymers as are known in the art.

In another embodiment the compositions of this invention further comprising any of the thermoplastic resins described above may be blended with the inventive elastomer to form dynamically vulcanized alloys.

The term “dynamic vulcanization” is used herein to connote a vulcanization process in which the vulcanizable elastomer is vulcanized in the presence of a thermoplastic under conditions of high shear and elevated temperature. As a result, the vulcanizable elastomer is simultaneously crosslinked and preferably becomes dispersed as fine particles of a “micro gel” within the thermoplastic. The resulting material is often referred to as a dynamically vulcanized alloy (“DVA”).

Dynamic vulcanization is effected by mixing the ingredients at a temperature which is at or above the curing temperature of the elastomer in equipment such as roll mills, Banbury™. mixers, continuous mixers, kneaders, or mixing extruders, e.g., twin screw extruders. The unique characteristic of the dynamically cured compositions is that, notwithstanding the fact that the elastomer component may be fully cured, the compositions can be processed and reprocessed by conventional thermoplastic processing techniques such as extrusion, injection molding, compression molding, etc. Scrap or flashing can also be salvaged and reprocessed; those skilled in the art will appreciate that conventional elastomeric thermoset scrap, comprising only elastomer polymers, cannot readily be reprocessed due to the cross-linking characteristics of the vulcanized polymer.

In forming DVAs in accordance with this embodiment, any of the above described thermoplastic resins may be used. Preferred thermoplastics are polyamides. The more preferred polyamides are nylon 6 and nylon 11. Preferably the thermoplastic polymer(s) may suitably be present in an amount ranging from about 10 to 98 weight percent, preferably from about 20 to 95 weight percent, the elastomer may be present in an amount ranging from about 2 to 90 weight percent, preferably from about 5 to 80 weight percent, based on the polymer blend. Preferably the elastomer is present in the DVA as particles dispersed in the thermoplastic polymer.

In the DVA, the elastomer may be present in a range from up to 90 phr in one embodiment, from up to 50 phr in another embodiment, from up to 40 phr in another embodiment, and from up to 30 phr in yet another embodiment. In yet another embodiment, the elastomer may be present from at least 2 phr, and from at least 5 phr in another embodiment, and from at least 5 phr in yet another embodiment, and from at least 10 phr in yet another embodiment. A desirable embodiment may include any combination of any upper phr limit and any lower phr limit.

### Compounding Additives

As already presented in Table 2, the disclosed elastomeric polymer may be blended with additional components to achieve a fully compounded elastomer/rubber. Possible additional components includes conventional fillers, nanofillers, processing aids and oils, and cure packages.

Conventional elastomeric fillers are, for example, calcium carbonate, silica, non-organic clay, talc, titanium dioxide, and carbon black. One or more of the fillers may be used. As used herein, silica is meant to refer to any type or particle size silica or another silicic acid derivative, or silicic acid, processed by solution, pyrogenic or the like methods and having a surface area, including untreated, precipitated silica, crystalline silica, colloidal silica, aluminum or calcium silicates, fumed silica, and the like.

In one embodiment, the filler is carbon black or modified carbon black, and combinations of any of these. In another embodiment, the filler is a blend of carbon black and silica. Conventional filler amounts for tire treads and sidewalls is reinforcing grade carbon black present at a level of from 10 to 100 phr of the blend, more preferably from 30 to 80 phr in another embodiment, and from 50 to 80 phr in yet another embodiment.

### Nanofiller

In other embodiments, the elastomer described above having a high styrene content and defined halogen content may further incorporate a nanofiller, optionally treated or pre-treated with a modifying agent, to form a nanocomposite polymer or a nanocomposite composition.

The nanofiller may be a silicitas, graphenes, carbon nanotubes, expandable graphite oxides, carbonates, metal oxides, or talcs. The nanofiller is defined as a “nano” due to its size, with a maximum dimension in the range of from about 0.0001 μm to about 100 μm. The other characteristic of a nanofiller is the high ratio of surface area to volume; this is in distinction to a fine grain carbon black that might have a very small maximum dimension but which has a low ratio of surface area to volume per grain. This high ratio of surface area to volume provides the nanofiller with a sheet-like structure. Such materials are typically agglomerated, resulting in a layered nanofiller.

In certain embodiments, the silicate may comprise at least one “smectite” or “smectite-type nanoclay” referring to the general class of nanoclay minerals with expanding crystal lattices. For example, this may include the dioctahedral smectites which consist of montmorillonite, beidellite, and nontronite, and the trioctahedral smectites, which includes saponite, hectorite, and sauconite. Also encompassed are synthetically prepared smectite-clays.

In yet other embodiments, the silicate may comprise natural or synthetic phyllosilicates, such as montmorillonite, nontronite, beidellite, bentonite, volkonskoite, laponite, hectorite, saponite, sauconite, magadite, kenyaite, stevensite and the like, as well as vermiculite, halloysite, aluminate oxides, hydrotalcite, and the like. Combinations of any of the previous embodiments are also contemplated.

The layered nanofillers, such as the layered clays described above, may be modified by intercalation or exfoliation by at least one agent or additive capable of undergoing ion exchange reactions with the cations present at the interlayer surfaces of the layered filler. The agents or additives are selected for their capability of undergoing ion exchange reactions with the cations present at the interlayer surfaces of the layered filler. Suitable exfoliating additives include cationic surfactants such as ammonium, alkylamines, or alkylammonium (primary, secondary, tertiary, and quaternary), phosphonium or sulfonium derivatives of aliphatic, aromatic or arylaliphatic amines, phosphines and sulfides. Such agents and additives are alternatively referred to as modifying, swelling, or exfoliating agent depending on the perceived physical result on the layered nanofiller.

Examples of some commercial modified nanoclay products are Cloisites produced by Southern Clay Products, Inc. in Gonzales, Tex. For example, Cloisite Na⁺, Cloisite 30B, Cloisite 10A, Cloisite 25A, Cloisite 93A, Cloisite 20A, Cloisite 15A, and Cloisite 6A. They are also available as SOMASIF and LUCENTITE clays produced by CO-OP Chemical Co., LTD. In Tokyo, Japan. For example, SOMASIF™ MAE, SOMASIF™ MEE, SOMASIF™ MPE, SOMASIF™ MTE, SOMASIF™ ME-100, LUCENTITE™ SPN, and LUCENTITE (SWN).

Nanocomposites can be formed using a variety of processes, such as emulsion blending, solution blending, and melt blending. However, by no means are these processes exhaustive of nanocomposite productions.

### Melt Blending

The nanocomposite of the present invention can be formed by a polymer melt blending process. Blending of the components can be carried out by combining the polymer components and the nanoclay in the form of an intercalate in any suitable mixing device such as a Banbury™ mixer, Brabender™ mixer or preferably a mixer/extruder and mixing at temperatures in the range of 120° C. up to 300° C. under conditions of shear sufficient to allow the nanoclay intercalate to exfoliate and become uniformly dispersed within the polymer to form the nanocomposite.

### Emulsion Processes

In the emulsion process, an aqueous slurry of inorganic nanoclay is mixed with a polymer dissolved in a solvent (cement). The mixing should be sufficiently vigorous to form emulsions or micro-emulsions. In some embodiments, the emulsions can be formed as an aqueous solution or suspension in an organic solution. Standard methods and equipment for both lab and large-scale production, including batch and continuous processes may be used to produce the polymeric nanocomposites of the invention.

In certain embodiments, a nanocomposite is produced by a process comprising contacting Solution A comprising water and at least one layered nanoclay with Solution B comprising a solvent and at least one elastomer; and removing the solvent and water from the contact product of Solution A and Solution B to recover a nanocomposite. In certain embodiments, the emulsion is formed by subjecting the mixture to agitation using a high-shear mixer.

In some embodiments, a nanocomposite is produced by a process comprising contacting Solution A comprising water and at least one layered nanoclay with Solution B comprising a solvent and at least one elastomer, wherein the contacting is performed in the presence of an emulsifier or surfactant.

The emulsions are formed by subjecting a mixture of the hydrocarbon, water and surfactant when used, to sufficient shearing, as in a commercial blender or its equivalent for a period of time sufficient for forming the emulsion, e.g., generally at least a few seconds. The emulsion can be allowed to remain in emulsion form, with or without continuous or intermittent mixing or agitation, with or without heating or other temperature control, for a period sufficient to enhance exfoliation of the nanoclay, from 0.1 to 100 hours or more in one embodiment, from 1 to 50 hours in another embodiment, and from 2 to 20 hours in another embodiment.

When used, the surfactant concentration is sufficient to allow the formation of a relatively stable emulsion. Preferably, the amount of surfactant employed is at least 0.001 weight percent of the total emulsion, more preferably about 0.001 to about 3 weight percent, and most preferably 0.01 to less than 2 weight percent.

Cationic surfactants useful in preparing the emulsions of this invention include tertiary amines, diamines, polyamines, amine salts, as well as quaternary ammonium compounds. Non-ionic surfactants useful in preparing the emulsions of this invention include alkyl ethoxylates, linear alcohol ethoxylates, alkyl glucosides, amide ethoxylates, amine ethoxylates (coco-, tallow-, and oleyl-amine ethoxylates for example), phenol ethoxylates, and nonyl phenol ethoxylates.

### Solution Blending

In the solution process, a nanocomposite is produced by contacting Solution A comprising a solvent and at least one layered filler or nanoclay with Solution B comprising a solvent and at least one elastomer, and removing the solvents from the contact product of Solution A and Solution B to form a nanocomposite.

The layered filler may be a layered nanoclay treated with organic molecules as described above. In yet another embodiment, a nanocomposite is produced by a process comprising contacting at least one elastomer and at least one layered filler in a solvent; and removing the solvent from the contact product to form a nanocomposite.

In another embodiment, a nanocomposite is produced by a process comprising contacting at least one elastomer and at least one layered filler in a solvent mixture comprising two solvents; and removing the solvent mixture from the contact product to form a nanocomposite.

In still another embodiment, a nanocomposite is produced by a process comprising contacting at least one elastomer and at least one layered filler in a solvent mixture comprising at least two or more solvents; and removing the solvent mixture from the contact product to form a nanocomposite.

In another embodiment, a nanocomposite is produced by a process to form a contact product comprising dissolving at least one elastomer and then dispersing at least one layered filler in a solvent or solvent mixture comprising at least two solvents; and removing the solvent mixture from the contact product to form a nanocomposite.

In yet another embodiment, a nanocomposite is produced by a process to form a contact product comprising dispersing at least one layered filler and then dissolving at least one elastomer in a solvent or solvent mixture comprising at least two solvents; and removing the solvent mixture from the contact product to form a nanocomposite.

In the embodiments described above, solvents may be present in the production of the nanocomposite composition from 30 to 99 wt %, alternatively from 40 to 99 wt %, alternatively from 50 to 99 wt %, alternatively from 60 to 99 wt %, alternatively from 70 to 99 wt %, alternatively from 80 to 99 wt %, alternatively from 90 to 99 wt %, alternatively from 95 to 99 wt %, based upon the total wt of the composition.

Additionally, in certain embodiments, when two or more solvents are prepared in the production of the nanocomposite composition, each solvent may comprise from 0.1 to 99.9 vol. %, alternatively from 1 to 99 vol. %, alternatively from 5 to 95 vol. %, and alternatively from 10 to 90 vol. %, with the total volume of all solvents present at 100 vol. %.

The amount of nanoclay incorporated in the nanocomposites, regardless of the method used to so incorporate the nanoclay, should be sufficient to develop an improvement in the mechanical properties or barrier properties of the nanocomposite, for example, tensile strength or oxygen permeability. Amounts generally will range from 0.5 to 10 wt % in one embodiment, and from 1 to 5 wt % in another embodiment, based on the polymer content of the nanocomposite. Expressed in parts per hundred rubber (phr), the nanoclay may be present from 1 to 50 phr in one embodiment, from 5 to 20 phr in another embodiment, from 5 to 10 phr in another embodiment, and 5 phr or 10 phr in yet other embodiments.

In fully formulated compounds, when using an emulsion or solution process to mix the copolymer and the nanoclay which yields a preblended nanocomposite elastomer, the amount of based elastomer, the nanocomposite, is expressed in parts per hundred nanocomposite (phn). The nanocomposite will be prepared to have a defined nanoclay loading amount.

Conventional bromobutyl based innerliner compounds have a permeation coefficient of between 200 and 200 cc·mm/m²·day. Relative to such compositions, the BIMSM base polymer described above, and used in the nanocomposites, preferably has an oxygen permeation coefficient of about 170 cc·mm/m²·day at 40° C. or lower as measured on cured compositions or articles as described herein. For an elastomer compound comprising the nanocomposite formed from any of the above described processes, the oxygen permeation coefficient is 150 cc·mm/m²·day at 40° C. or lower, 140 cc·mm/m²·day at 40° C. or lower, 130 cc·mm/m²·day at 40° C. or lower, 120 cc·mm/m²·day at 40° C. or lower, 110 cc·mm/m²·day at 40° C. or lower, 100 cc·mm/m²·day at 40° C. or lower, 90 cc·mm/m²·day at 40° C. or lower, or 80 cc·mm/m²·day at 40° C. or lower.

Examples of a compounded nanocomposite comprising the isobutylene copolymer having a styrene substitute and halogen content within the ranges specified above were prepared to determine the cure and physical characteristics of both the nano-copolymer and the compounded nanocomposite, see Table 4 below. The nanoclay was added to the compound via melt mixing in the manner discussed above. Loadings of up to 50 phr of nanoclay were made to determine the effect on the mechanical properties of the fully formulated innerliner compound. For the examples in Table 4, the base innerliner composition, as used in the examples shown in Table 2, is used for the elastomeric nanocomposite innerliner composition.

Oxygen permeability was measured using a Mocon Ox-Tran Model 2/61 oxygen transmission rate test apparatus and Perm-Net operating system (ASTM D3985). There are six cells per instrument where gas transmission through each test sample in a cell is measured individually. A zero reading to establish a baseline is obtained and samples are then tested at 40° C. and 60° C. Oxygen transmission is measured with an O2 detector. Data is reported as a Permeation Coefficient in cc*mm/(m2-day) and Permeability Coefficient in cc*mm/(m2-day-mmHg).

The testing of nanocomposite Compounds 7 to 12 evidences a few relevant points about compound BIMSM X when blended with a layered nanoclay in comparison to the commercial bromobutyl copolymer.

The highest cure state was achieved with a nanoclay loading of 10 phr. Vulcanization rates (see peak rate data) dropped significantly once the nanoclay loading was above 10 phr. Additionally, beyond a 10 phr nanoclay loading, the elongation at break began to deteriorate. At 20 phr nanoclay, the tensile strength was improved, though this also deteriorated at higher nanoclay loadings, and the improvement in tensile strength is a trade-off with vulcanization properties. At 50 phr nanoclay, while the permeability coefficient was very low, the material became more brittle-like, evidenced by the drop off in 300% modulus and tear strength.

With all the nanoclay loadings, the permeability characteristics of the compound improved. Again, for nanocomposites of higher nanoclay loading the improvement in impermeability is a trade-off with the vulcanization properties.

TABLE 4

| Compound | 6 | 7 | 8 | 9 | 10 | 11 | 12 |
|---|---|---|---|---|---|---|---|
| Bromobutyl 2222 | 100.00 | | | | | | |
| BIMSM X | | 100.00 | 100.00 | 100.00 | 100.00 | 100.00 | 100.00 |
| Cloisite Na+¹ | — | 5.0 | 10.0 | 20.0 | 30.0 | 40.0 | 50.0 |
| Carbon Black | 60.00 | 60.00 | 60.00 | 60.00 | 60.00 | 60.00 | 60.00 |
| Napthanic oil | 8.00 | 8.00 | 8.00 | 8.00 | 8.00 | 8.00 | 8.00 |
| Resin | 7.00 | 7.00 | 7.00 | 7.00 | 7.00 | 7.00 | 7.00 |
| Phenolic tackifier | 4.00 | 4.00 | 4.00 | 4.00 | 4.00 | 4.00 | 4.00 |
| Stearic acid | 1.00 | 1.00 | 1.00 | 1.00 | 1.00 | 1.00 | 1.00 |
| Zinc oxide | 1.00 | 1.00 | 1.00 | 1.00 | 1.00 | 1.00 | 1.00 |
| MBTS | 1.25 | 1.25 | 1.25 | 1.25 | 1.25 | 1.25 | 1.25 |
| Sulfur | 0.50 | 0.50 | 0.50 | 0.50 | 0.50 | 0.50 | 0.50 |
| Vulcanization Kinetics, 180° C., | | | | | | | |
| ASTM D5038 | | | | | | | |
| MH-ML, dNm | 3.17 | 6.21 | 6.25 | 6.08 | 6.07 | 5.75 | 4.76 |
| t10, minutes | 0.89 | 1.53 | 1.77 | 2.27 | 2.62 | 2.67 | 2.37 |
| t90, minutes | 2.73 | 4.38 | 6.65 | 14.66 | 21.36 | 23.76 | 24.59 |
| Peak Rate, dNm/min | 2.37 | 2.75 | 1.7 | 0.77 | 0.52 | 0.4 | 0.32 |
| Activation energy, KJ/mol | 89.6 | 88.8 | 81.2 | 76.1 | 82.7 | 71.4 | 64.4 |
| Cure Rate Index | 54.35 | 35.09 | 20.49 | 8.07 | 5.34 | 4.74 | 4.50 |
| Tensile Strength, MPa, ASTM D412 | 8.22 | 8.39 | 7.28 | 8.22 | 7.14 | 5.28 | 3.54 |
| Elongation at break, %, ASTM D412 | 770 | 790 | 770 | 750 | 740 | 690 | 690 |
| 300% Modulus, MPa, ASTM D412 | 2.54 | 4.68 | 3.92 | 5.17 | 4.63 | 3.75 | 3.30 |
| Shore Hardness A, ASTM D2240 | 41 | 52 | 50 | 55 | 56 | 57 | 58 |
| Die B Tear Strength, N/mm | 33.56 | 41.48 | 37.78 | 42.52 | 40.79 | 39.92 | 33.19 |
| Permeability | | | | | | | |
| Permeation Rate, cc * mm/m² · day | 278 | 165 | 151 | 146 | 128 | 114 | 106 |
| Permeation Coeff., cc * mm/m² · | 0.414 | 0.246 | 0.225 | 0.217 | 0.19 | 0.169 | 0.156 |
| day · mmHg | | | | | | | |
| Rating | 100 | 59 | 54 | 53 | 46 | 41 | 38 |

¹Closite Na⁺ from Southern Clay Products, Gonzales, Tx. Montmorillonite clay

### Crosslinking Agents, Curatives, Cure Packages, and Curing Processes

Generally, polymer blends, for example, those used to produce tires, are crosslinked thereby improve the polymer's mechanical properties. It is known that the physical properties, performance characteristics, and durability of vulcanized rubber compounds are directly related to the number (crosslink density) and type of crosslinks formed during the vulcanization reaction.

In certain embodiments of the present invention, the elastomeric compositions and the articles made from those compositions may comprise at least one curative or crosslinking agent to enable the elastomer to undergo a process to cure the elastomeric composition. As used herein, at least one curative package refers to any material or method capable of imparting cured properties to a rubber as commonly understood in the industry. At least one curative package may include any and at least one of the following.

One or more crosslinking agents are preferably used in the elastomeric compositions of the present invention, especially when silica is the primary filler, or is present in combination with another filler. Suitable curing components include sulfur, metal oxides, organometallic compounds, and radical initiators.

Peroxide cure systems or resin cure systems may also be used. However, if the elastomer is being combined with a thermoplastic to form a DVA (where no cross-linking of the thermoplastic is desired), the use of peroxide curative may be avoided if the thermoplastic resin is one such that the presence of peroxide would cause the thermoplastic resin to cross-link.

Sulfur is the most common chemical vulcanizing agent for diene-containing elastomers. It exists as a rhombic eight member ring or in amorphous polymeric forms. A typical sulfur vulcanization system consists of the accelerator to activate the sulfur, an activator, and a retarder to help control the rate of vulcanization. The accelerator serves to control the onset of and rate of vulcanization, and the number and type of sulfur crosslinks that are formed. Activators may also be used in combination with the curative and accelerator. The activate reacts first with the accelerators to form rubber-soluble complexes which then react with the sulfur to form sulfurating agents. General classes of activators include amines, diamines, guanidines, thioureas, thiazoles, thiurams, sulfenamides, sulfenimides, thiocarbamates, xanthates, and the like. Retarders may be used to delay the initial onset of cure in order to allow sufficient time to process the unvulcanized rubber.

Halogen-containing elastomers such as the inventive halogenated poly(isobutylene-co-p-methylstyrene) may be crosslinked by their reaction with metal oxides. The metal oxide is thought to react with halogen groups in the polymer to produce an active intermediate which then reacts further to produce carbon-carbon bonds. Metal halides are liberated as a by-product and can serve as autocatalysts for this reaction. Common curatives include ZnO, CaO, MgO, Al2O3, CrO3, FeO, Fe2O3, and NiO. These metal oxides can be used alone or in conjunction with the corresponding metal fatty acid complex (e.g., the stearate salts of Zn, Ca, Mg, and Al), or with stearic acid and either a sulfur compound or an alkylperoxide compound. More preferably, the coupling agent may be a bifunctional organosilane crosslinking agent. An “organosilane crosslinking agent” is any silane coupled filler and/or crosslinking activator and/or silane reinforcing agent known to those skilled in the art including, but not limited to, vinyl triethoxysilane, vinyl-tris-(beta-methoxyethoxy)silane, methacryloylpropyltrimethoxysilane, gamma-amino-propyl triethoxysilane (sold commercially as A1100 by Witco), gamma-mercaptopropyltrimethoxysilane (A189 by Witco) and the like, and mixtures thereof. In one embodiment, bis-(3-triethoxysilypropyl)tetrasulfide (sold commercially as “Si69”) is employed.

The mechanism for accelerated vulcanization of elastomers involves complex interactions between the curative, accelerator, activators and polymers. Ideally, all available curative is consumed in the formation of effective crosslinks which join together two polymer chains and enhance the overall strength of the polymer matrix. Numerous accelerators are known in the art and include, but are not limited to, the following: stearic acid, diphenyl guanidine, tetramethylthiuram disulfide, 4,4′-dithiodimorpholine, tetrabutylthiuram disulfide, benzothiazyl disulfide, hexamethylene-1,6-bisthiosulfate disodium salt dihydrate (sold commercially as DURALINK™ HTS by Flexsys), 2-morpholinothio benzothiazole (MBS or MOR), blends of 90% MOR and 10% MBTS (MOR 90), N-tertiarybutyl-2-benzothiazole sulfenamide, and N-oxydiethylene thiocarbamyl-N-oxydiethylene sulfonamide, zinc 2-ethyl hexanoate, and thioureas.

Due to the nature of the nanoclay, and the surfactants and swelling agents used in combination with the nanoclay, the inventors also chose to examine the effects of different accelerants on nanocomposite compounds. The accelerators chosen were mercaptobenzothiazole disulfide (MBTS), mercaptobenzothiazole (MBT), cyclohexyl benzothiazole disulfide (CBS), dibutyl thiourea (DBTU), tetramethylthiuram disulfide (TMTD), 4-4-dithiodimropholine (DTDM), zinc dimethyldithiocarbamate (ZDMC), and zinc dibutylphosphorodithiate (ZDBP).

The compounds used the same innerliner formulation as set forth in Table 2. The BIMSM X nanocomposite was first formed via a solution mixing process as described above to obtain a nanoclay loading of 7 wt % in the nanocomposite. The nanoclay used was Cloisite Na+. The compound formulations with the components expressed in amounts of parts per hundred nanocomposite (phn), vulcanization properties, and solid strength properties are provided below in Table 5.

TABLE 5

| Compound | 13 | 14 | 15 | 16 | 17 | 18 | 19 | 20 |
|---|---|---|---|---|---|---|---|---|
| BIMSM X | 100.00 | | | | | | | |
| Nanocomposite | | 100.00 | 100.00 | 100.00 | 100.00 | 100.00 | 100.00 | 100.00 |
| Cloisite Na+ | 7.0 | | | | | | | |
| Carbon Black | 60.00 | 60.00 | 60.00 | 60.00 | 60.00 | 60.00 | 60.00 | 60.00 |
| Napthanic oil | 8.00 | 3.00 | 3.00 | 3.00 | 3.00 | 3.00 | 3.00 | 3.5 |
| Resin | 7.00 | 7.00 | 7.00 | 7.00 | 7.00 | 7.00 | 7.00 | 7.00 |
| Phenolic tackifier | 4.00 | 4.00 | 4.00 | 4.00 | 4.00 | 4.00 | 4.00 | 4.00 |
| Stearic acid | 1.00 | 1.00 | 1.00 | 1.00 | 1.00 | 1.00 | 1.00 | 1.00 |
| Zinc oxide | 3.00 | 3.00 | 3.00 | 3.00 | 3.00 | 3.00 | 3.00 | 1.00 |
| Sulfur | 0.50 | 0.50 | 0.50 | 0.50 | 0.50 | 0.50 | 0.50 | 0.50 |
| MBTS | 1.25 | — | — | — | — | — | — | 1.25 |
| MBT | — | 1.50 | — | — | — | — | — | — |
| CBS | — | — | 1.25 | — | — | — | 1.25 | — |
| DBTU | — | — | — | 2.00 | — | — | — | 1.0 |
| TMTD | — | — | — | — | 2.00 | — | — | — |
| DTDM | — | — | — | — | — | 2.00 | — | — |
| ZBPD | — | — | — | — | — | — | 2.00 | — |
| Vulcanization Kinetics, | | | | | | | | |
| 160ÈC, ASTM D2084 | | | | | | | | |
| MH-ML, dNm | 3.64 | 2.60 | 4.22 | 5.12 | 2.88 | 3.28 | 2.55 | 3.9 |
| t10, minutes | 1.74 | 1.49 | 1.25 | 0.35 | 0.66 | 0.92 | 1.25 | 1.1 |
| t90, minutes | 20.37 | 7.93 | 17.70 | 1.11 | 2.10 | 12.67 | 12.34 | 12.4 |
| Peak Rate, dNm/min | 0.40 | 0.50 | 0.57 | 12.35 | 2.62 | 0.71 | 0.49 | — |
| Cure Rate Index | 5.49 | 13.64 | 6.04 | 105.26 | 59.88 | 8.98 | 8.61 | — |
| Tensile Strength, MPa, | 9.5 | 8.4 | 10.3 | 13.4 | 9.5 | 9.3 | 8.6 | 10.5 |
| ASTM D412 | | | | | | | | |
| Elongation at break, %, | 556 | 786 | 733 | 473 | 753 | 805 | 745 | 678 |
| ASTM D412 | | | | | | | | |
| 300% Modulus, MPa, | 6.5 | 4.0 | 5.4 | 8.1 | 4.2 | 4.7 | 4.2 | 4.8 |
| ASTM D412 | | | | | | | | |
| Shore Hardness A, ASTM | 54.9 | 52.9 | 56.1 | 58.1 | 51.9 | 52.7 | 49.7 | 58.1 |
| D2240 | | | | | | | | |
| Die B Tear Strength, N/mm | 63.3 | 52.2 | 51.7 | 47.8 | 52.0 | 51.4 | 46.6 | 53.1 |
| Permeability Coeff., | 0.414 | 0.430 | 0.415 | 0.378 | 0.371 | 0.424 | 0.440 | — |
| cc * mm/m² · day · mmHg | | | | | | | | |
| Permeability Rating | 58 | 60 | 58 | 53 | 52 | 59 | 61 | — |

For permeability rating of the above compounds, compound 6 is used as the baseline 100. The compounds using aromatic accelerators, compounds 13-15 and 18 showed a higher permeability average. Compounds 16 and 17 exhibited the lowest permeability rating, as well as the shortest scorch or induction time as evidenced by the t10 values. This suggests there may be a relationship between impermeability and cure induction time. For further comparison, compound 20 uses a blend of two accelerators. The scorch and cure times, as well as the solid strength characteristics seem to fall within the values for when the individual accelerators are used alone.

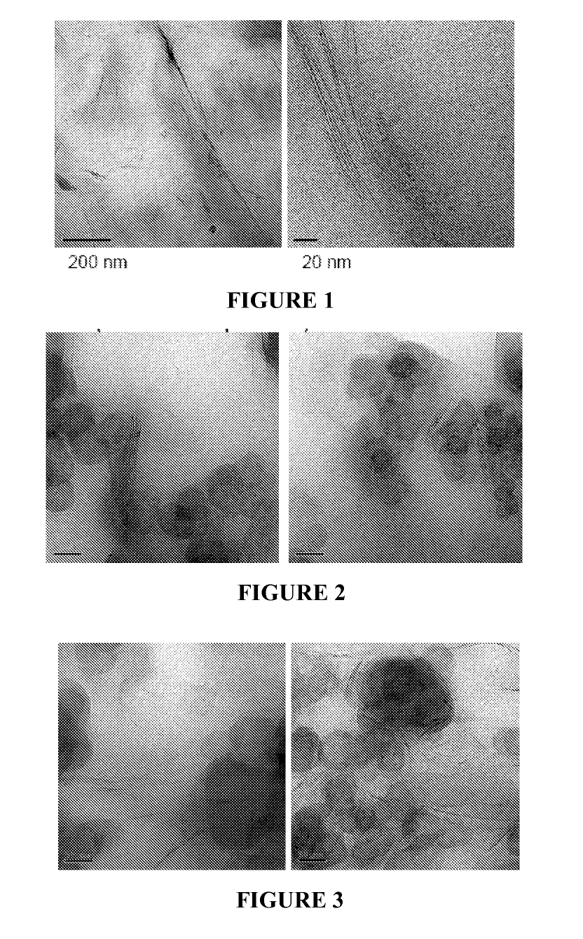

To further examine the interaction of the cure package and the permeability of both the nanocomposite and the formulated nanocomposite compound, both the individual nanocomposite and the compound were examined via micrographs. FIG. 1 shows are TEM micrographs of an uncompounded nanocomposite comprising 7 wt % of nanoclay. The micrographs at 200 nm and 20 nm, respectively from left to right, show the nanoclay is very well dispersed and an intercalated-flocculated condition has been achieved. The background light grey is the BISMX copolymer, and the thin lines are the montmorillonite clay plates. The nanoclay plates have a nominal diameter in the order of 70 to 100 nm.

The formulated nanocomposite compound was also examined, and TEM micrographs are shown in FIG. 2. The micrographs of FIG. 2 were taken at 50 nm. The large black objects in the TEM micrographs are the carbon black, the grey background is the elastomeric copolymer, and the thin lines are the nanoclay plates. The compound contains 7 wt % of nanoclay, 60 phr N660 grade carbon black, 3.5 phr naphthenic oil, 0.50 phr sulfur, 1.0 phr zinc oxide, and 1.25 phr MBTS accelerator. In a carbon black reinforced elastomeric nanocomposite, when the nanoclay plates become associated with a carbon black particle or aggregate, the contribution to increasing the tortuous path through the compound (desired for reduced permeability) may be negated. The association shown in FIG. 2 is believed to be due to polar functional groups on the surface of the carbon black attracting the nanoclays.

Compound 20 of Table 5, incorporating 1.00 phn of DBTU into the compound, is shown in the TEM micrographs, taken at 50 nm, of FIG. 3. The incorporation of DBTU reduces the scorch time of the compound and increases the Mooney viscosity. In FIG. 3, it can be seen that there is an apparent decrease in the amount of nanoclay associated with the carbon black; there are nanoclay layers not associated with the carbon black. Thus, there is more nanoclay to aid in creation of the desired tortuous path to reduce permeability to oxygen and nitrogen through the compound.

The compositions produced in accordance with the present invention typically contain other components and additives customarily used in rubber mixes, such as effective amounts of other nondiscolored and nondiscoloring processing aids, processing oils, pigments, antioxidants, and/or antiozonants.

### Processing for Elastomeric Compounds

Blends of elastomers may be reactor blends and/or melt mixes. Mixing of the components may be carried out by combining the polymer components, filler and the nanoclay in the form of an intercalate in any suitable mixing device such as a two-roll open mill, Brabender™ internal mixer, Banbury™ internal mixer with tangential rotors, Krupp internal mixer with intermeshing rotors, or preferably a mixer/extruder, by techniques known in the art. Mixing is performed at temperatures in the range from up to the melting point of the elastomer and/or secondary rubber used in the composition in one embodiment, from 40° C. up to 250° C. in another embodiment, and from 100° C. to 200° C. in yet another embodiment, under conditions of shear sufficient to allow the nanoclay intercalate to exfoliate and become uniformly dispersed within the polymer to form the nanocomposite.

Typically, from 70% to 100% of the elastomer or elastomers is first mixed for 20 to 90 seconds, or until the temperature reaches from 40° C. to 75° C. Then, ¾ of the filler, and the remaining amount of elastomer, if any, is typically added to the mixer, and mixing continues until the temperature reaches from 90 to 150° C. Next, the remaining filler is added, as well as the processing oil, and mixing continues until the temperature reaches from 140 to 190° C. The masterbatch mixture is then finished by sheeting on an open mill and allowed to cool, for example, to from 60° C. to 100° C. when the curatives are added.

### INDUSTRIAL APPLICABILITY

The invention, accordingly, provides the following embodiments:
A. A copolymer of an isoolefin having from 4 to 7 carbon atoms and an alkylstyrene, said copolymer having a substantially homogeneous compositional distribution and comprising from about 8 to about 12 wt % of alkylstyrene and from about 1.1 to about 1.5 wt % of a halogen and wherein said copolymer has a ratio of Mw/Mn of less than about 6;
B. The copolymer of embodiment A, wherein the halogen is selected from either chlorine or bromine;
C. The copolymer of embodiment A or B, wherein the alkylstyrene is para-methylstyrene and the isoolefin comprises isobutylene;
D. The copolymer of any preceding embodiments A to C, wherein the alkylstyrene is functionalized with the halogen, and up to 25 mol % of the alkylstyrene is so functionalized;
E. The copolymer of embodiment D, wherein from 10 to 25 mol % of the alkylstyrene is functionalized by the halogen;
F. The copolymer of any preceding embodiments A to E, wherein the copolymer is blended with a secondary polymer to form a compound, the compound containing from 5 to 90 phr of the copolymer;
G. The copolymer of embodiment F, wherein the secondary polymer is selected from the group consisting of natural rubbers, polybutadiene rubber, polyisoprene rubber, poly(styrene-co-butadiene) rubber, poly(isoprene-co-butadiene) rubber, styrene-isoprene-butadiene rubber, ethylene-propylene rubber, ethylene-propylene-diene rubber, isobutene-isoprene rubber, halogenated butyl rubber, star branched butyl rubber, and mixtures thereof;
H. The copolymer of any preceding embodiments A to G, wherein the copolymer is blended with at least one component selected from the group consisting of fillers, processing oils, and cure packages;
I. The copolymer of any preceding embodiments A to H, wherein the copolymer is blended with a thermoplastic polymers selected from the group consisting of polyamides, polyimides, polycarbonates, polyesters, polysulfones, polylactones, polyacetals, acrylonitrile-butadiene-styrene polymers, polyphenyleneoxide, polyphenylene sulfide, polystyrene, styrene-acrylonitrile polymers, styrene maleic anhydride polymers, aromatic polyketones, poly(phenylene ether), and mixtures thereof;
J. The copolymer of embodiment I, wherein the copolymer and the thermoplastic polymer are dynamically vulcanized together under conditions of high shear wherein the copolymer is dispersed as fine particles within the thermoplastic polymer;
K. The copolymer of any of the preceding embodiments A to J, wherein the copolymer is blended with at least one nanofiller, the nanofiller being selected from the group consisting of silicitas, graphenes, carbon nanotubes, expandable graphite oxides, carbonates, metal oxides, and talcs;
L. The copolymer of any of the preceding embodiments A to K, wherein the nanofiller is at least one silicate and the at least one silicate is selected from the group consisting of natural or synthetic phyllosilicates, montmorillonite, nontronite, beidellite, bentonite, volkonskoite, laponite, hectorite, saponite, sauconite, magadite, kenyaite, stevensite, vermiculite, halloysite, aluminate oxides, and hydrotalcite; and
M. The copolymer of either embodiment K or L, wherein the copolymer is further blended with at least one cure accelerator, and the at least one cure accelerator is selected from the group consisting of mercaptobenzothiazole disulfide, mercaptobenzothiazole, cyclohexyl benzothiazole disulfide, dibutyl thiourea, tetramethylthiuram disulfide, 4-4-dithiodimropholine, zinc dimethyldithiocarbamate, and zinc dibutylphosphorodithiate.

The elastomeric compositions of the invention may be extruded, compression molded, blow molded, injection molded, and laminated into various shaped articles including fibers, films, laminates, layers, industrial parts such as automotive parts, appliance housings, consumer products, packaging, and the like.

The elastomeric compositions as described above may be used in the manufacture of air membranes such as innerliners, innertubes sidewalls, treads, bladders, and the like used in the production of tires. Methods and equipment used to manufacture the innerliners and tires are well known in the art. The invention is not limited to any particular method of manufacture for articles such as innerliners or tires. In particular, the elastomeric compositions are useful in articles for a variety of tire applications such as truck tires, bus tires, automobile tires, motorcycle tires, off-road tires, aircraft tires, and the like.

In another application, the elastomeric compositions may be employed in air cushions, pneumatic springs, air bellows, hoses, accumulator bags, and belts such as conveyor belts or automotive belts. They are useful in molded rubber parts and find wide applications in automobile suspension bumpers, auto exhaust hangers, and body mounts.

Additionally, the elastomeric compositions may also be used as adhesives, caulks, sealants, and glazing compounds. They are also useful as plasticizers in rubber formulations; as components to compositions that are manufactured into stretch-wrap films; as dispersants for lubricants; and in potting and electrical cable filling materials.

All priority documents, patents, publications, and patent applications, test procedures (such as ASTM methods), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. A copolymer of an isoolefin having from 4 to 7 carbon atoms and an alkylstyrene, said copolymer having a substantially homogeneous compositional distribution and comprising from about 8 to about 12 wt % of alkylstyrene and from about 1.1 to about 1.5 wt % of a halogen and wherein said copolymer has a ratio of Mw/Mn of less than about 6.

2. The copolymer of claim 1, wherein the halogen is selected from either chlorine or bromine.

3. The copolymer of claim 1, wherein the alkylstyrene is para-methylstyrene and the isoolefin comprises isobutylene.

4. The copolymer of claim 1, wherein the alkylstyrene is functionalized with the halogen, and up to 25 mol % of the alkylstyrene is so functionalized.

5. The copolymer of claim 4, wherein from 10 to 25 mol % of the alkylstyrene is functionalized by the halogen.

6. The copolymer of claim 1, wherein the copolymer is blended with a secondary polymer to form a compound, the compound containing from 5 to 90 phr of the copolymer.

7. The copolymer of claim 6, wherein the secondary polymer is selected from the group consisting of natural rubbers, polybutadiene rubber, polyisoprene rubber, poly(styrene-co-butadiene) rubber, poly(isoprene-co-butadiene) rubber, styrene-isoprene-butadiene rubber, ethylene-propylene rubber, ethylene-propylene-diene rubber, isobutene-isoprene rubber, halogenated butyl rubber, star branched butyl rubber, and mixtures thereof.

8. The copolymer of claim 1, wherein the copolymer is blended with at least one component selected from the group consisting of fillers, processing oils, and cure packages.

9. The copolymer of claim 1, wherein the copolymer is blended with a thermoplastic polymers selected from the group consisting of polyamides, polyimides, polycarbonates, polyesters, polysulfones, polylactones, polyacetals, acrylonitrile-butadiene-styrene polymers, polyphenyleneoxide, polyphenylene sulfide, polystyrene, styrene-acrylonitrile polymers, styrene maleic anhydride polymers, aromatic polyketones, poly(phenylene ether), and mixtures thereof.

10. The copolymer of claim 9, wherein the copolymer and the thermoplastic polymer are dynamically vulcanized together under conditions of high shear wherein the copolymer is dispersed as fine particles within the thermoplastic polymer.

11. The copolymer of claim 1, wherein the copolymer is blended with at least one nanofiller, the nanofiller being selected from the group consisting of silicitas, graphenes, carbon nanotubes, expandable graphite oxides, carbonates, metal oxides, and talcs.

12. The copolymer of claim 11, wherein the nanofiller is at least one silicate and the at least one silicate is selected from the group consisting of natural or synthetic phyllosilicates, montmorillonite, nontronite, beidellite, bentonite, volkonskoite, laponite, hectorite, saponite, sauconite, magadite, kenyaite, stevensite, vermiculite, halloysite, aluminate oxides, and hydrotalcite.

13. The copolymer of claim 12, wherein the copolymer is further blended with at least one cure accelerator, and the at least one cure accelerator is selected from the group consisting of mercaptobenzothiazole disulfide, mercaptobenzothiazole, cyclohexyl benzothiazole disulfide, dibutyl thiourea, tetramethylthiuram disulfide, 4-4-dithiodimropholine, zinc dimethyldithiocarbamate, and zinc dibutylphosphorodithiate.
